(19) United States
(12) Patent Application Publication
(10) Pub. No.: US 2014/0099155 A1
(43) Pub. Date: Apr. 10, 2014

(54) Connection Unit For Slide Of Rod

(71) Applicant: Jingsheng Chen, Xiamen City (CN)

(72) Inventor: Jingsheng Chen, Xiamen City (CN)

(73) Assignee: XIAMEN XINTIANDA CORPORATION DEVELOPMENT LTD. CO.

(21) Appl. No.: 13/644,467

(22) Filed: Oct. 4, 2012

(51) Int. Cl. F16B 7/14

(52) U.S. Cl. 403/83

(57) ABSTRACT

A connection unit cooperates with a rod when in use. The connection unit includes a fixing member, a pin rod, an oblique detent and a knob. The fixing member has an axial slide hole for insertion of the rod and a transverse hole. The pin rod has a slope at a middle section thereof corresponding to the oblique detent. The pin rod is driven by the knob. The oblique detent is fixed on the fixing member. The connection unit can be applied for connection of two rods or for positioning of a fixing member of a rod. The operation is simply and labor-saving. The connection unit can be widely used.

### BACKGROUND OF THE INVENTION

1. Field of the Invention

The present invention relates to a connection unit for a rod, and more particularly to a connection unit for slide of a rod.

2. Description of the Prior Art

There are various positioning structures on the market for a rod or the fixing member of a rod. In general, a positioning hole cooperates with an elastic protrusion to position the rod. As shown in FIG. 1, the positioning structure comprises a rod 1 and an outer sleeve 3. The rod 1 has an elastic protrusion 2 therein. The protrusion 2 extends out of a through hole 11 of the rod 1. The outer sleeve 3 has at least one positioning hole 31 or positioning slot. When the protrusion 2 is engaged with the positioning hole 31, the outer sleeve 3 and the rod 1 will be positioned.

The aforesaid positioning structure for a rod can be widely used, such as the positioning of an extendable rod. The rod 1 is the inner pipe of the extendable rod, and the outer sleeve 3 is the outer pipe of the extendable rod. The extendable rod can be used for the pole of a tent, the rod of a foldable beach chair or the rod of a mop. When in use, the extendable rod can be extended. When not in use, the extendable rod is retracted. The extendable rod can adjust its length for different demands.

The aforesaid positioning structure can be used to position a fixing member at different positions of a support rod, for example, to position a support rod of a tent. The rod 1 is the support rod, and the outer sleeve 3 is the fixing member.

According to the aforesaid positioning structure, the protrusion 2 has elasticity. When the protrusion 2 is aligned with the positioning hole 31, the protrusion 2 will be engaged in the positioning hole 31 automatically. The positioning way is very convenient. However, when the user wants to release the positioning, he/she has to press the protrusion 2 with his/her finger so that the protrusion 2 is retracted in the outer sleeve 3. The protrusion is small and has elasticity. It is difficult to press the protrusion and the operation is not convenient. This way uses the finger to release the positioning. After that, the rod 1 is slid. Before the protrusion 2 is retracted into outer sleeve 3, it may hurt the finger.

Another product is provided with a button on the rod to press the protrusion so as to release the positioning. However, when this configuration is applied to a large-sized product, such as a large-sized tent, the user has to apply enough force to press the button because the rod is thick and the protrusion has larger hardness so the operation is also inconvenient.

Besides, the aforesaid fixing structure is provided with an elastic protrusion in the inner rod to increase the cost for assembly.

Accordingly, the inventor of the present invention has devoted himself based on his many years of practical experiences to solve this problem.

### SUMMARY OF THE INVENTION

The primary object of the present invention is to provide a connection unit for slide of a rod. The connection unit is operated with ease and labor-saving and can be widely used.

According to a first aspect of the present invention, the connection unit cooperates with a rod when in use. The rod comprises an elastic protrusion therein. The elastic protrusion extends out of a through hole of the rod. The connection unit comprises a fixing member, a pin rod, an oblique detent and a knob. The fixing member has an axial slide hole and is fitted on the rod. The fixing member further has a transverse hole. The pin rod has a slope at a middle section thereof corresponding to the oblique detent. The slope faces one side of the knob. The pin rod is driven by the knob. The oblique detent is fixed on the fixing member and located at one side of the knob.

Preferably, the rod comprises a plurality of elastic protrusions therein.

Preferably, the fixing member has a fixing trough for engagement of the elastic protrusions.

Preferably, the rod comprises an inner pipe and an outer pipe. The elastic protrusion is disposed in the inner pipe and extends out of a through hole of the inner pipe. The outer pipe has a positioning hole for engagement of the elastic protrusion.

Preferably, an elastic member is provided with the pin rod and the fixing member.

Preferably, the oblique detent is formed on a fixing plate. The fixing plate is installed at one end of an accommodation trough of the fixing member. The accommodation trough is disposed at an outer side of the transverse hole of the fixing member. The accommodation trough is adapted to accommodate the pin rod and the elastic member.

Preferably, the fixing member has a fixing trough for engagement of the elastic protrusion.

According to a second aspect of the present invention, the connection unit cooperates with a rod when in use. The rod comprises an inner pipe and an outer pipe. The inner pipe has at least one positioning hole. The connection unit comprises a fixing member, a pin rod, an oblique detent, a knob and an elastic member. The fixing member has an axial slide hole and is fitted on the outer pipe. The fixing member further has a transverse hole. The pin rod has a slope at a middle section thereof corresponding to the oblique detent. The slope faces one side of the fixing member. The pin rod is driven by the knob. The elastic member is against the outer side of the pin rod. The inner end of the pin rod extends into the slide hole of the fixing member in a normal state. The oblique detent is formed on the fixing member and disposed beside the transverse hole.

Preferably, the fixing member has an accommodation trough at the outer side of the transverse hole. A fixing plate is secured to the end of the accommodation trough. The elastic member is located between the fixing plate and the pin rod. The accommodation trough is adapted to accommodate the pin rod and the elastic member.

The pin rod of the present invention has the slope and is driven by the knob. When rotated, the pin rod is pushed by the oblique detent to move inward or outward. This simple turning action achieves the purpose to release the positioning. The operation is simple and convenient and won't hurt the finger. Besides, the oblique detent mates with the slope to convert the press force into twist force, so it is more laborious for the release action. Furthermore, the pin rod can function as the button to release the positioning or as the elastic protrusion for positioning. The present invention can cooperate with the elastic protrusion of the existing rod. The pin rod may function as the elastic protrusion so the present invention can be used widely.

### BRIEF DESCRIPTION OF THE DRAWINGS

FIG. 1 is a sectional view of a conventional rod positioning structure;

FIG. 2 is an exploded view according to a first embodiment of the present invention;

FIG. 3 is another exploded view according to the first embodiment of the present invention;

FIG. 4 is a perspective view according to the first embodiment of the present invention;

FIG. 5 is a sectional view according to the first embodiment of the present invention;

FIG. 6 is a side view according to the first embodiment of the present invention when the knob is rotated;

FIG. 7 is a sectional view showing that the pin rod is pushed out according to the first embodiment of the present invention;

FIG. 8 is a side view showing that the knob is returned automatically after loosened according to the first embodiment of the present invention;

FIG. 9 is an exploded view according to a second embodiment of the present invention;

FIG. 10 is another exploded view according to the second embodiment of the present invention;

FIG. 11 is a perspective view according to the second embodiment of the present invention;

FIG. 12 is a sectional view according to the second embodiment of the present invention;

FIG. 13 is a side view according to the second embodiment of the present invention when the knob is rotated;

FIG. 14 is a sectional view showing that the pin rod is pushed out according to the second embodiment of the present invention;

FIG. 15 is a side view showing that the knob is returned automatically after loosened according to the second embodiment of the present invention;

FIG. 16 is a schematic view showing the first and second embodiments applied to a tent support frame;

FIG. 16A is an enlarged view taken from circle A of FIG. 16;

FIG. 16B is an enlarged view taken from circle B of FIG. 16;

FIG. 17 is a schematic view showing the tent support frame of FIG. 16 in a folded state;

FIG. 18 is a schematic view showing the first embodiment applied to an extendable rod.

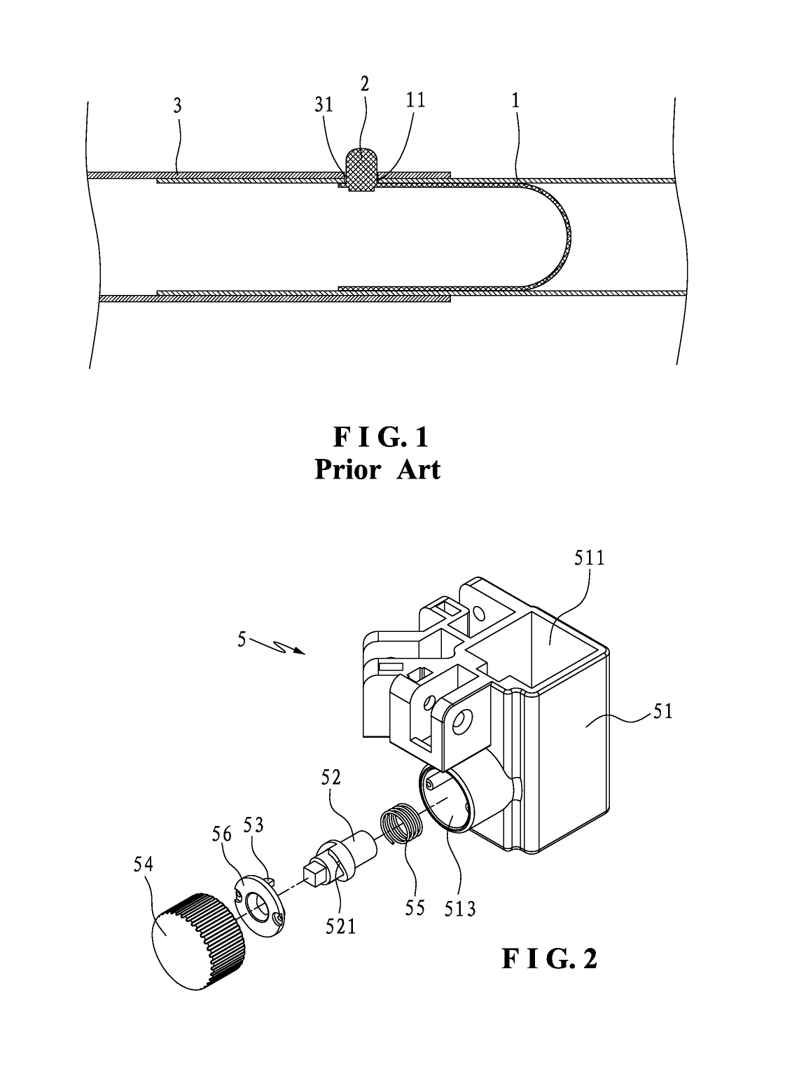

### DETAILED DESCRIPTION OF THE PREFERRED EMBODIMENTS

Embodiments of the present invention will now be described, by way of example only, with reference to the accompanying drawings.

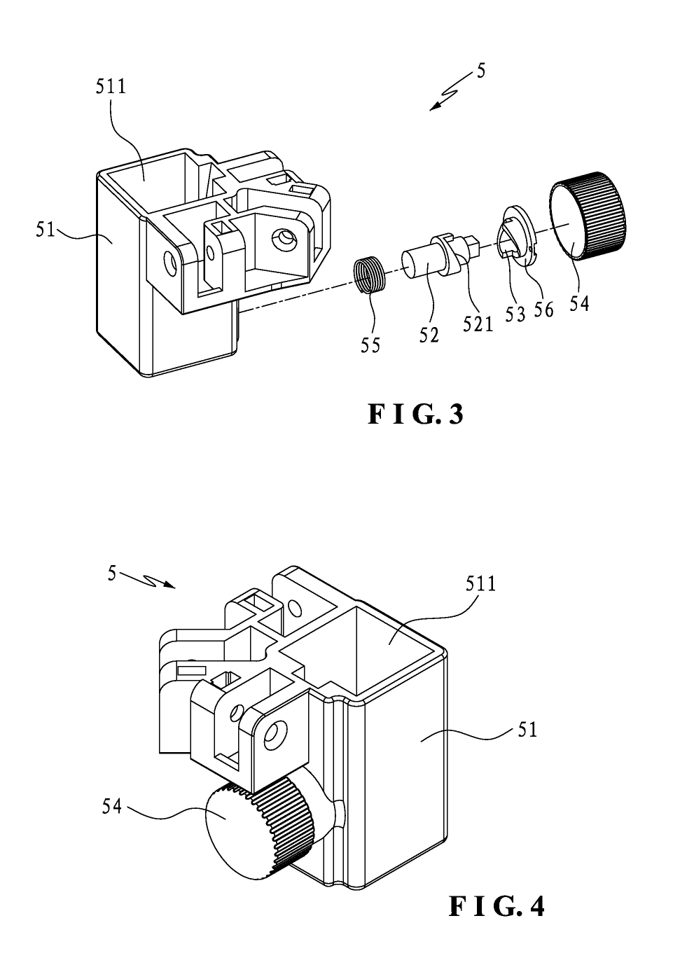

The present invention discloses a connection unit 5 for slide of a rod. FIG. 2 to FIG. 5 shows a first embodiment of the present invention. When in use, the connection unit 5 cooperates with a rod 4. An elastic protrusion 2 is provided in the rod 4. The elastic protrusion 2 extends out of a through hole 421 of the rod 4.

The connection unit 5 comprises a fixing member 51, a pin rod 52, an oblique detent 53, and a knob 54.

The fixing member 51 has an axial slide hole 511 and is fitted on the rod 4. The fixing member 51 further has a transverse hole 512.

The pin rod 52 has a slope 521 at a middle section thereof corresponding to the oblique detent 53. The slope 521 faces one side of the knob 54. The pin rod 52 is driven by the knob 54. For homing of the pin rod 52, an elastic member 55 is provided with the pin rod 52 and the fixing member 51.

The oblique detent 53 is fixed on the fixing member 51 and located at one side of the knob 54. For fixing the oblique detent 53, the oblique detent 53 is formed on a fixing plate 56. The fixing plate 56 is installed at one end of an accommodation trough 513 of the fixing member 51. The accommodation trough 513 is disposed at an outer side of the transverse hole 512 of the fixing member. The accommodation trough 513 is adapted to accommodate the pin rod 52 and the elastic member 55.

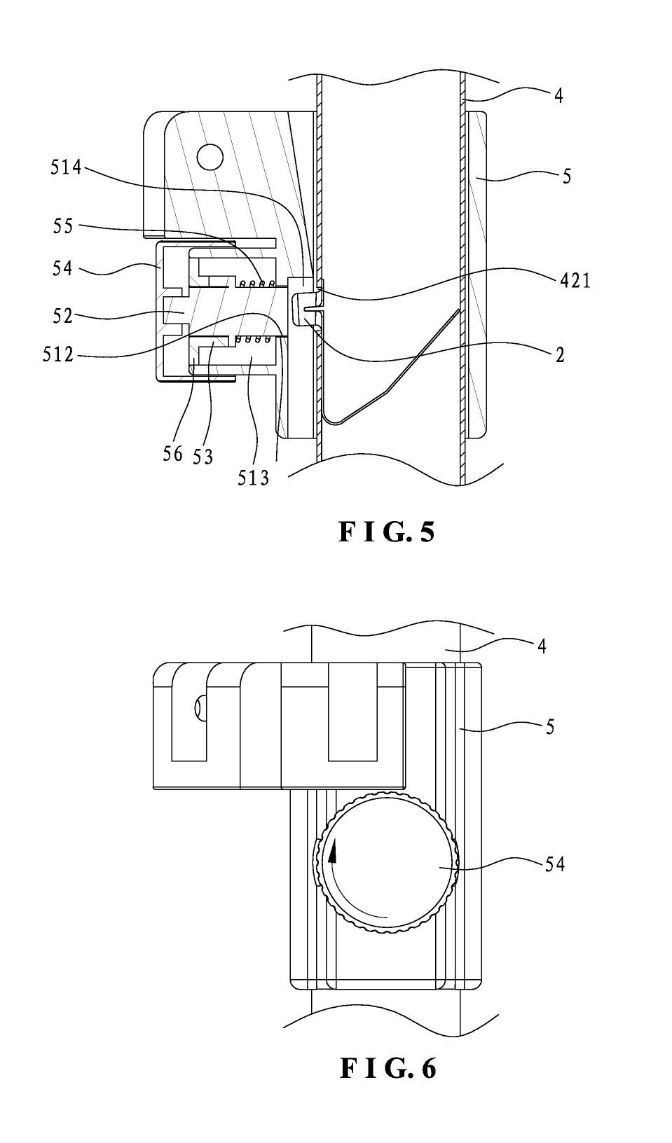

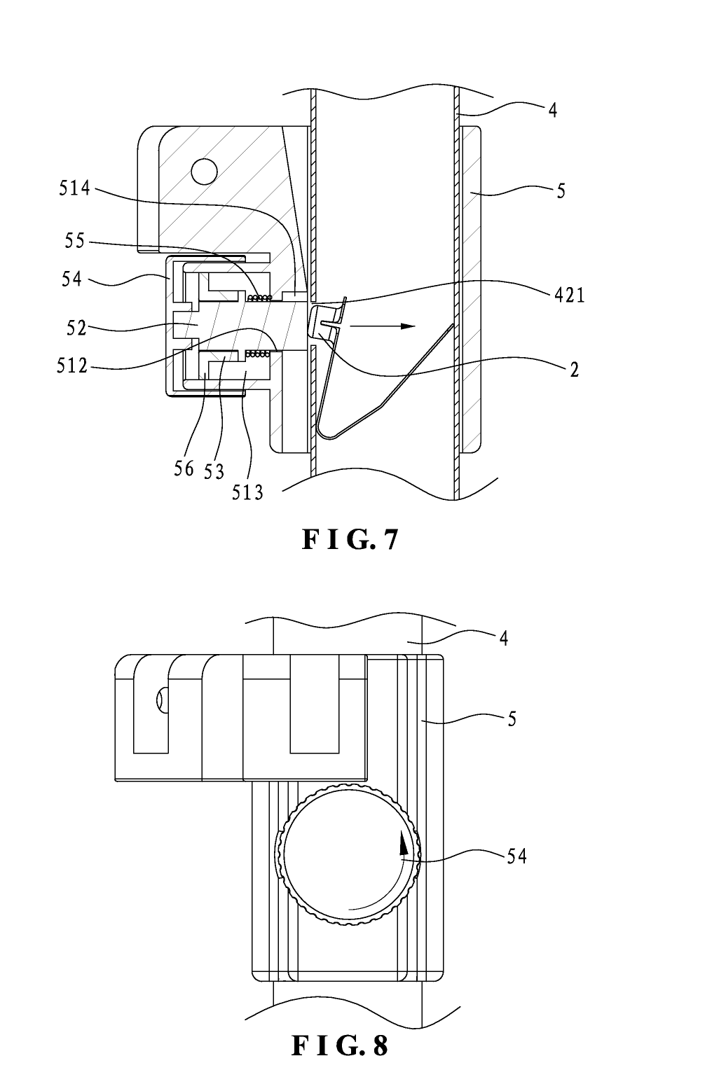

As shown in FIG. 5, the connection unit 5 is in a normal state. The elastic protrusion 2 in the rod 4 is positioned in the transverse hole 512 of the fixing member 51. The pin rod 52 biased by the elastic protrusion 2 or the elastic member 55 is positioned at the outer side. For stable positioning, the fixing member 51 has a positioning trough 514 for engagement of the elastic protrusion 2. As shown in FIG. 5, the fixing member 51 is secured on the rod 4. The fixing member 51 may be further connected with other components, so that the other components can be secured on the rod 4. To release the positioning, as shown in FIG. 6, the knob 54 is turned to bring rotation of the pin rod 52. The slope 521 of the pin rod 52 is pushed by the oblique detent 53 to move inward so as to push the elastic protrusion 2. As shown in FIG. 7, the elastic protrusion 2 disengages from the transverse hole 512 or the positioning trough 514 to release the positioning, such that the fixing member 51 can be slid as desired. The fixing member 51 can bring movement of the other components. When the knob 54 is loosened, the pin rod 52 biased by the elastic member 55 will automatically move outward and bring the knob 54 to turn back. As shown in FIG. 8, when the fixing member 51 is slid to another elastic protrusion or the same elastic protrusion of the rod 4, the elastic protrusion 2 will mate with the transverse hole 512 or the positioning trough 514 of the fixing member 51 to restore its normal positioning state. As shown in FIG. 5, if there is no elastic member 55, the pin rod 52 and the knob 54 also can be restored by the elastic protrusion 2.

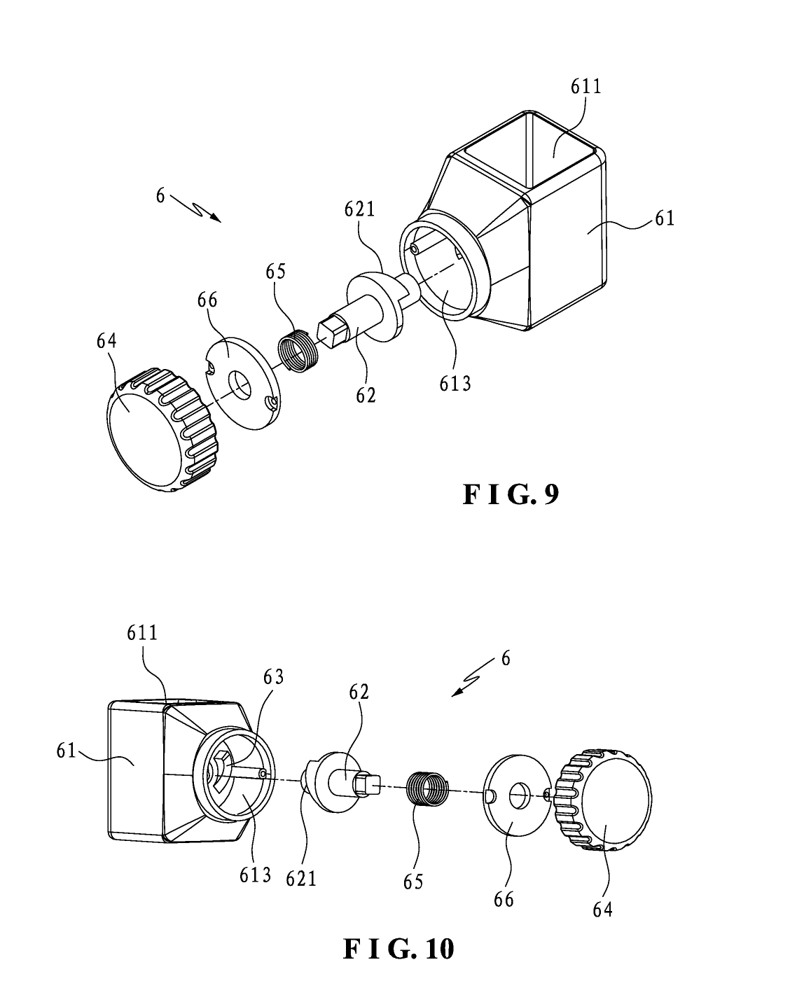

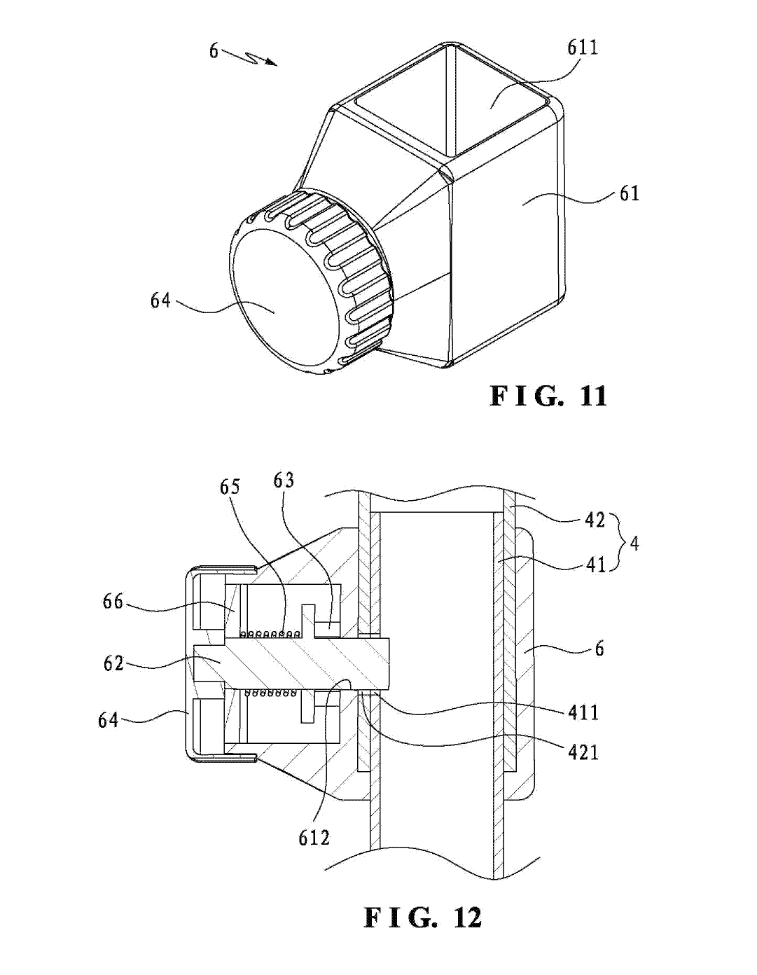

FIG. 9 to FIG. 12 shows a second embodiment of the present invention. In this embodiment, the connection unit 6 cooperates with a rod 4. The rod 4 comprises an inner pipe 41 and an outer pipe 42. The inner pipe 41 has at least one positioning hole 411.

The connection unit 6 comprises a fixing member 61, a pin rod 62, an oblique detent 63, a knob 64, and an elastic member 65.

The fixing member 61 has an axial slide hole 611 and is fitted on the outer pipe 42. The fixing member 61 further has a transverse hole 612.

The pin rod 62 has a slope 621 at a middle section thereof corresponding to the oblique detent 63. The slope 621 faces one side of the fixing member 61. The pin rod 62 is driven by the knob 64.

The elastic member 65 is against the outer side of the pin rod 62, such that the inner end of the pin rod 62 extends into the slide hole 611 of the fixing member 61 in a normal state. For installation of the elastic member 65, the fixing member 61 has an accommodation trough 613 at the outer side of the transverse hole 612. A fixing plate 66 is secured to the end of the accommodation trough 613. The elastic member 65 is located between the fixing plate 66 and the pin rod 62. The accommodation trough 613 is adapted to accommodate the pin rod 62 and the elastic member 65.

The oblique detent 63 is formed on the fixing member 61 and disposed beside the transverse hole 612.

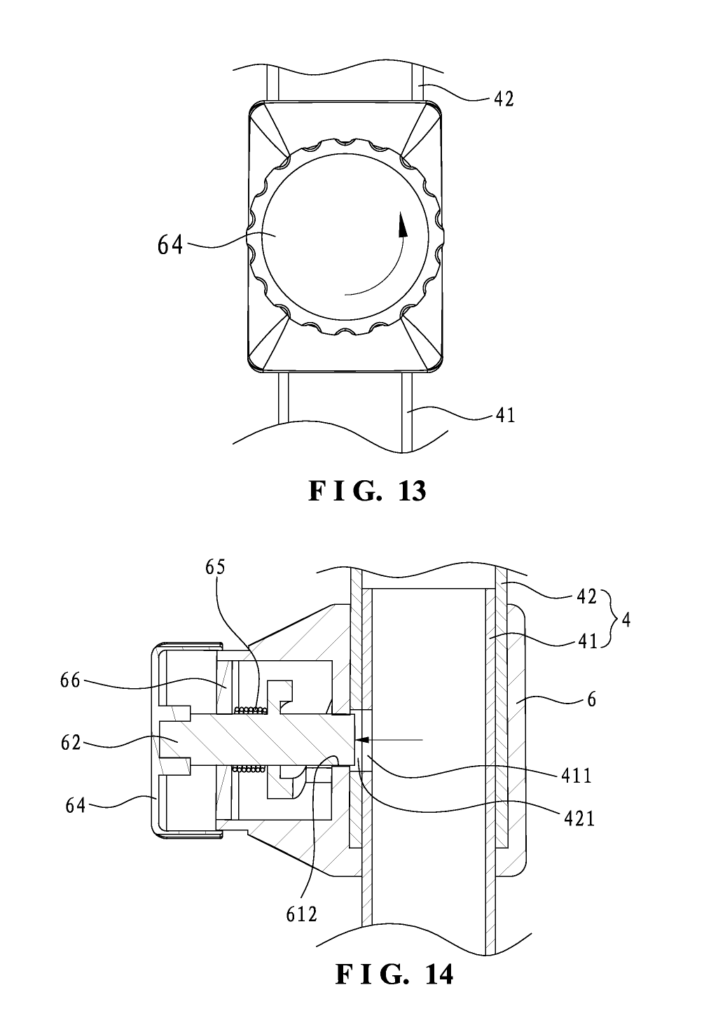

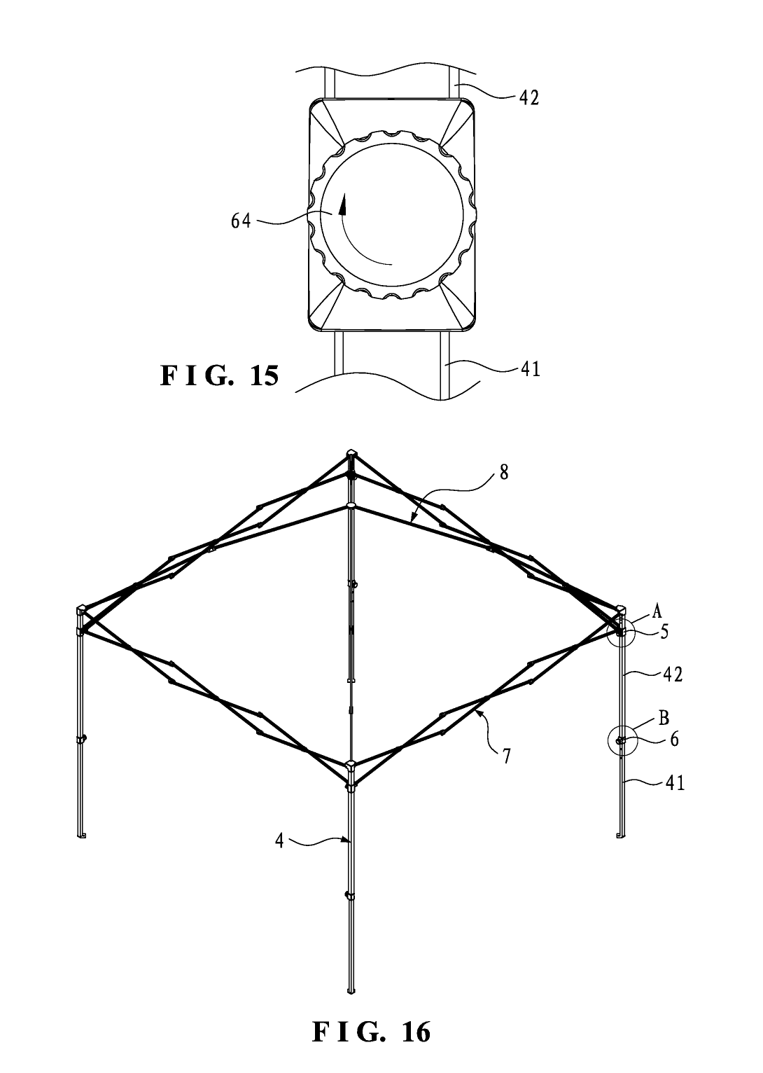

As shown in FIG. 12, the connection unit 6 is in a normal state. The pin rod 62 biased by the elastic member 65 is inserted into the slide hole 611 of the fixing member 61 and in the outer pipe 42 and positioned in one of the positioning holes 411 of the inner pipe 41, so that the inner pipe 41 and the outer pipe 42 are positioned. To release the positioning, as shown in FIG. 13, the knob 64 is turned to bring rotation of the pin rod 62. The slope 621 of the pin rod 62 is pushed by the oblique detent 63 to move outward, such that the pin rod 62 disengages from the positioning hole 411 of the inner pipe 41. As shown in FIG. 14, the positioning is released so that the inner and outer pipes can be slidablly moved as desired. When the knob 64 is loosened, the pin rod 62 biased by the elastic member 65 will automatically move inward and bring the knob 64 to turn back. As shown in FIG. 15, when another positioning hole 411 of the inner pipe 41 is aligned with the inner end of the pin rod 62, the pin rod 62 biased by the elastic member 65 is engaged in the positioning hole 411 to restore its normal positioning state, as shown in FIG. 12.

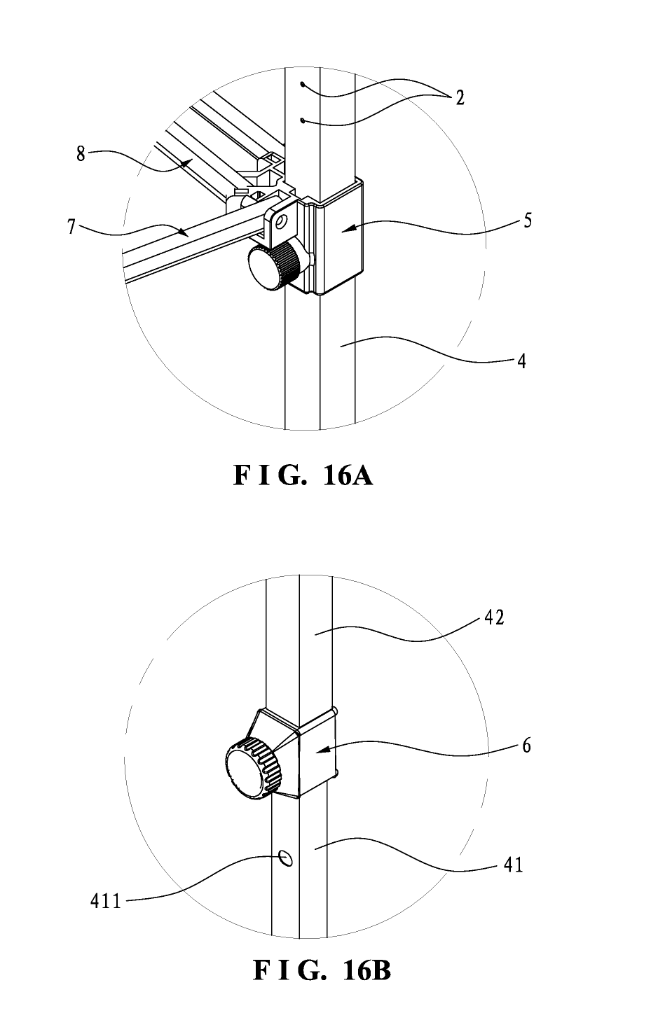

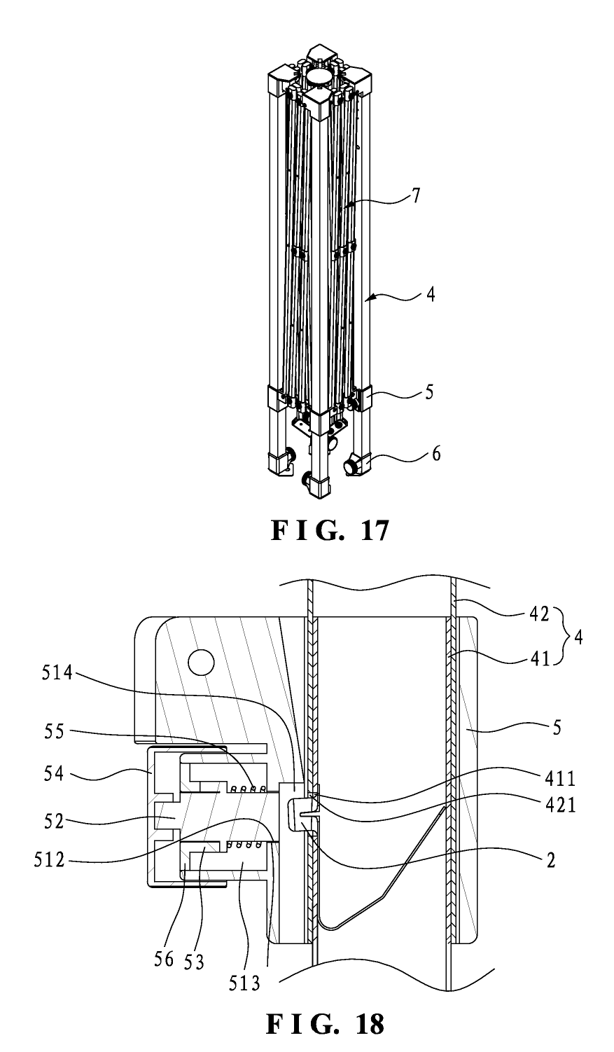

FIG. 16 is a schematic view showing the above-mentioned two embodiments applied to a tent support frame. The tent support frame comprises poles 4 (equivalent to the rods 4), a side support rod unit 7, a top support rod unit 8. Each pole 4 comprises an inner pipe 41 and an outer pipe 42. The connection unit 5 of the first embodiment is fitted on the pole 4. The outer side rods of the side support rod unit 7 and the top support rod unit 8 are pivotally connected to the fixing member 51 of the connection unit 5, as shown in FIG. 16A. When the connection unit 5 is slidably moved to the upper of the pole 4, one of the elastic protrusions 2 of the pole 4 will engage with the connection unit 5 to support and secure the side support rod unit 7 and the top support rod unit 8 quickly so as to unfold the tent. When the positioning of the connection unit 5 is released, the connection unit 5 will slide to the lower of the pole 4 to fold the tent, as shown in FIG. 17. The connection unit 6 of the second embodiment is secured to the lower end of the outer pipe 42 of the pole 4 to adjust the height of the pole 4. When the user wants to release the positioning, the inner pipe 41 is retracted into the outer pipe 42 to decrease the height of the tent when the tent is folded.

The difference between the aforesaid two embodiments is that the pin rod of the first embodiment is equivalent to the button to release the positioning, so it has to mate with a rod having an elastic protrusion. In other words, the aforesaid embodiment may cooperate with the positioning structure of the existing rod. The pin rod of the second embodiment is a positioning member, equivalent to an elastic protrusion disposed on the outside of the rod so there is no need for the elastic protrusion provided in the rod. This structure doesn't need to install the elastic protrusion to lower the manufacture cost of the product.

The connection unit 5 of the first embodiment can be applied to an extendable rod having an elastic protrusion. As shown in FIG. 18, the extendable rod 4 has the inner pipe 41 and the outer pipe 42. The inner pipe 41 comprises at least one elastic protrusion 2 therein. The elastic protrusion 2 extends out of the through hole 412 of the inner pipe 41. The outer pipe 42 has the positioning hole 422. The connection unit 5 is secured to the end of the outer pipe 42 corresponding the position to the positioning hole 422. When in a normal engagement state, one of the elastic protrusions 2 of the inner pipe 41 is engaged in the positioning hole 422 of the outer pipe 42, so that the extendable rod 4 is extended and positioned. When the positioning is released, the rod can be retracted or positioned at another position. The other numerical members are same as the first embodiments.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A connection unit for slide of a rod, the connection unit cooperating with the rod when in use, the rod comprising an elastic protrusion therein, the elastic protrusion extending out of a through hole of the rod; the connection unit comprising a fixing member, a pin rod, an oblique detent and a knob; the fixing member having an axial slide hole and being fitted on the rod; the fixing member further having a transverse hole; the pin rod having a slope at a middle section thereof corresponding to the oblique detent, the slope facing one side of the knob, the pin rod being driven by the knob; the oblique detent being fixed on the fixing member and located at one side of the knob.

2. The connection unit as claimed in claim 1, wherein the fixing member has a fixing trough for engagement of the elastic protrusion.

3. The connection unit as claimed in claim 1, wherein the rod comprising a plurality of elastic protrusions therein.

4. The connection unit as claimed in claim 3, wherein the fixing member has a fixing trough for engagement of the elastic protrusions.

5. The connection unit as claimed in claim 1, wherein the rod comprises an inner pipe and an outer pipe, the elastic protrusion being disposed in the inner pipe and extending out of a through hole of the inner pipe, the outer pipe having a positioning hole for engagement of the elastic protrusion.

6. The connection unit as claimed in claim 1, wherein an elastic member is provided with the pin rod and the fixing member.

7. The connection unit as claimed in claim 6, wherein the oblique detent is formed on a fixing plate, the fixing plate being installed at one end of an accommodation trough of the fixing member, the accommodation trough being disposed at an outer side of the transverse hole of the fixing member, the accommodation trough being adapted to accommodate the pin rod and the elastic member.

8. The connection unit as claimed in claim 7, wherein the fixing member has a fixing trough for engagement of the elastic protrusion.

9. A connection unit for slide of a rod, the connection unit cooperating with the rod when in use, the rod comprising an inner pipe and an outer pipe, the inner pipe having at least one positioning hole; the connection unit comprising a fixing member, a pin rod, an oblique detent, a knob and an elastic member; the fixing member having an axial slide hole and being fitted on the outer pipe, the fixing member further having a transverse hole; the pin rod having a slope at a middle section thereof corresponding to the oblique detent, the slope facing one side of the fixing member, the pin rod being driven by the knob; the elastic member being against an outer side of the pin rod, an inner end of the pin rod extending into the slide hole of the fixing member in a normal state; the oblique detent being formed on the fixing member and disposed beside the transverse hole.

10. The connection unit as claimed in claim 9, wherein the fixing member having an accommodation trough at an outer side of the transverse hole, a fixing plate being secured to an end of the accommodation trough, the elastic member being located between the fixing plate and the pin rod, the accommodation trough being adapted to accommodate the pin rod and the elastic member.
